(19) United States
(12) Patent Application Publication
(10) Pub. No.: US 2007/0053250 A1
(43) Pub. Date: Mar. 8, 2007

(54) Removable Laser Disc Mass Storage Device with Onboard Fast Access Memory

(75) Inventor: Albert Taan Wu, Paramus, NJ (US)

Correspondence Address: ALBERT T. WU, 187 WEST MIDLAND AVE., PARAMUS, NJ, 07652-1813, US

(73) Assignee: Mr. Albert Taan Wu, Paramus, NJ (US)

(21) Appl. No.: 11/162,131

(22) Filed: Aug. 30, 2005

(51) Int. Cl. G11B 21/08; G11B 7/24

(52) U.S. Cl. 369/30.86; 720/718

(57) ABSTRACT

This invention is a mass storage system based on laser disc technology. While there are various laser discs players available, they are all aimed at serving an audio/visual entertainment purpose with no consideration given to the ability of this type of media to service the vast amount of data created in the information age. This invention will help users manage a vast laser disc collection, secure all information through backup, and make volumetric data truly portable.

### REFERENCES CITED

U.S. Patent Documents

U.S. Pat. No. 5,631,882 May 1997 Mascenik

U.S. Pat. No. 5,751,672 May 1998 Yankowski

U.S. Pat. No. 6,147,940 November 2000 Yankowski

### SUMMARY OF THE INVENTION

The objective of this invention is to create an affordable mass storage system based on laser disc technology. This invention will cover both online and off-line mass storage features.

Another objective of this invention is to allow the magazine, which houses a vast amount of laser discs, to be used intact inside the data retrieving console and to be stored intact in the off-line docking structure. This invention will also provide the option and ability for the magazines to be stacked up without the docking structure, at user's discretion, for limited quantities.

An additional objective of this invention is to allow each magazine to establish its own onboard or add-on fast access discs' database, hereafter referred to as a magazine database, which contains enough information for the user to identify a specific disc in the shortest possible time. This design characteristic provides much needed convenience to the user because accessing each individual laser disc is too time-consuming. This feature will also remove the need for sorting through the entire magazine of laser discs each time after loading the magazine, which can take an extremely long time.

Another objective is to have the magazine database fused with the magazine structure. This will allow the magazine to be portable. Users can transport the magazine to other places, to connect with other data retrieval equipment of compatible design, and allow that equipment to network with any other computer without the need to rebuild the database.

A further objective of this invention is to build an automatic search and sorting program inside the data retrieval equipment. This program will automatically search through the entire magazine of laser discs and establish such a database as mentioned above by the push of a button at the user's discretion. A portion of this database will be derived from the table of content (TOC) of each disc and structured in a predetermined fashion. The user will be able to modify and add other portions such as keywords and descriptions to this database to facilitate search and sorting in the future.

The final objective of this invention is to create an off-line docking structure which not only provides physical space for one or more magazines to dock, but also provides an electromechanical infrastructure to support active management. This docking structure shall be furnished with various electronic interface ports. For the simplest application, the ports shall at least help the user manage the magazines and the discs by giving easy access to the database onboard all magazines. For more advanced setup, the infrastructure will network with a robotic transport system to allow automatic sorting and retrieval of the desired magazine.

### BACKGROUND

1. Field of the Invention

This invention relates generally to the field of mass data storage equipment. In particular, it relates to the equipment that organizes and manages considerable amount of laser disc as mass data storage media. This invention introduces pseudo online performance to the vast compact disc storage, which is conventionally considered as an off-line device. Additional electronic components can be added to handle files in audio/video format in real time. This will expand its scope from a pure data storage device to a data presenter of the content in audio and/or visual format.

2. Background of the Invention

It is the norm of our modern society to produce, transmit, and then file massive amount of information in an instance. Currently there are three types of preferred and financially viable mass storage devices: magnetic tape drive and its tape media, hard disc drive (“HDD”) and compact laser disc drive with its companion media, laser disc (“LD”). Here, LD is used to cover both types of laser disc, CD and DVD.

The magnetic tape technology is the remnant of the early main-frame era. It is on its way to be replaced. The HDD is perceived as a non-permanent storage media due to its re-writable physical property and the price structure, while the LD is believed to be much cheaper and much longer lasting. The LD was the preferred media form for content transaction in the last decade, and still is, despite the steady proliferation of Internet access. Therefore most offices and households have accumulated considerable amount of LDs with valuable content. The content covers all categories such as computer program, game, music, movie, audio book, etc. It becomes an issue to physically store and manage these valuable LDs.

With the proliferation of Internet come virus attacks. The frequency and ferocity of these attacks have steadily risen. The typical response includes adding virus scanning software protection and creating frequent backup files. For instance, the PC operating system Windows XP by Microsoft provides such backup function, which will restore the system to a known state after a non-recoverable crash, shall it be caused by a virus attack or otherwise. However the effectiveness of this function diminishes if the backup file is stored on a HDD, which, with its re-writable property, is often a target itself. On the other hand, a one-time programmable LD will no doubt be able to resist this type of virus attack or system crash. If the LD is employed for this purpose, one can expect a large number of LDs with periodic, say daily, backup files being produced and accumulated over time. An effective method of managing this accumulation is highly desirable.

In the meantime, there are both single and multiple LD devices available commercially. There are several types of the single LD device. The ones for PC are designed to be one of its I/O peripheral equipment. The majority of them are sold for loading the content of a LD onto the PC, while a certain number will allow the PC to download the content onto the LD for permanent record. Others are audio and visual presenting devices. Their function is to decode the content on the LD and present the result on a human audio and visual interface such as speaker and display panel. How to store and manage the LDs is the least of its design goals.

There are clearly two classes of multiple LD drives. The one with small capacity usually holds no more than a dozen LDs. It is usually found as car CD changer and CD-ROM for PC. It was designed for short-term convenience with little concern over the customer's entire LD collection. The other class holds from dozens CDs up to 300 CDs in its internal carrier cartridge. As of today, they are found in the form of music players sold by commercial concerns under brand names such as Sony and Panasonic. In the future, one can expect to find video players based on DVD technology marketed most likely by the same business concerns. The application limit (as audio and video player) placed on this class is probably due to the nature of the manufacturers' business model.

The large capacity multiple LD devices, with the ability to hold many LDs, were designed with organizing audio and video entertainment LDs in mind. However its primary function is still a music or video player, LD management and storage is just the byproduct. Therefore the large capacity LD carrier cartridge was designed to be permanently attached to the player during normal operation. It will only be detached for repair. In other words, these cartridges can only be labeled as “internal”. They were not designed to be easily taken out of the player. Nor were they designed to be stacked up easily in some designated storage space outside the player body. So in general terms the current devices are geared neither for LD storage nor for its management.

The initial access time of LD is notoriously slow. The time needed to sort through a large collection the LDs was beyond normal human patience. As described in U.S. Pat. No. 6,147,940, certain effort had been made to improve this performance for Sony products mentioned above. The solution is to pre-sort the entire internal cartridge and store the information on a remote PC via certain networking means. During playtime, the user can use the PC to control the play process based on the resident pre-sorted information database on the PC. However, once the player is moved outside the networking range from the PC, all controls are lost. Therefore this practice will inevitably marry the LD player to this specific PC permanently.

To accommodate the need to add, remove or replace LDs, mechanisms are employed. A common one is to build a sliding door on the front panel. This door will part, under the user's command, to present an opening. The desired slot of the internal cartridge will be positioned facing the opening for easy access. The user can load into or unload from the slot one LD at a time. This approach works fine when the user possesses only a relatively small cache of LDs. Whenever the collection of LDs outnumbers the number of slots in the internal cartridge, then the user has got headache at hand. At the best, the user has to resort to a tedious process. First, the user must store the excess LDs the old fashion way—most likely leaving them in random and un-traceable piles. Second, when any LD is needed from the piles, the user needs to find the particular LD, and then decides which LD must be removed from the cartridge and searches for it. Third, after accomplishing all these, the user has to go through the physical process of putting the LD into the slot by replacing, if any, the original one. Fourth, it is time for the user to manually update the database on PC, if it exists. In any case, this is certainly beyond the idea of proper LD management.

Facing this background environment, this invention targets to provide a new innovative family of systems that will eliminate the shortcomings altogether. First a removable and stackable magazine will be introduced to replace the immobile internal cartridge. Second, each magazine will be equipped with means to access onboard or add-on IC based non-volatile memory which holds the database that contains the information regarding each LD in the magazine. Third, a loading and unloading mechanism will be employed to allow the whole magazine being installed or removed in a very timely fashion. Fourth, a software package will facilitate automatic search, categorizing and recording of LD identifying information into the magazine database on that fast access non-volatile memory.

### BRIEF DESCRIPTION OF DRAWINGS

FIG. 1 displays one possible design of the internal structure of the operation console of this invention. It shows magazine 110 and laser disc loader 140 sitting on the platform 190 while electronic control module 170 is located in the back of the console.

FIG. 2 displays a block diagram of the essential electrical connections of the operation console.

FIG. 3 displays one of the preferred embodiments of storage rack unit 300 for safe and secure off-line storage of disc magazine 110.

FIG. 4 displays a block diagram of the electrical connection for storage rack unit 300.

FIG. 5 displays a block diagram of the normal sorting procedure for the entire content of disc magazine 110 under user command.

FIG. 6 displays a block diagram of the automatic updating procedure immediately after a disc magazine 110 is loaded.

FIG. 7 displays the flag setting mechanism for automatic update procedure.

FIG. 8 displays the accessory of a cover/carrying case 210 for magazine 110.

FIG. 9 displays another of the preferred embodiments with its vertical disc magazine 510 and corresponding disc loader 540 complemented with its electronic control module 570.

FIG. 10 displays yet another of the preferred embodiments with its carrousel disc magazine 710 and fixed disc loader 740 complemented with its electronic control module 770.

FIG. 11 displays the accessory of a cover/carrying case 810 for the magazine 710.

### DESCRIPTION OF PREFERRED EMBODIMENT

This invention described below may be realized in various embodiments. Since there is no way to cover them all, the present disclosure is to provide examples of the principles of the invention and not intended to limit the invention to the specific embodiments displayed and described. In the description below, reference numerals are used to add clarity to the description.

Based on laser disc technology, this invention is a low-cost mass data storage and retrieval system that is secure and easy to use. (The word “data” as it is used here takes a broad definition as to indicate any information, literal, audio, visual, or other, that can be represented in digital format.) This system is comprised of an operation console and an optional off-line storage structure.

The major function of the operation console is to load data onto or retrieve data from the storage media—laser discs. The operation console consists of three functional modules: (a) a disc magazine, (b) a laser disc loader and its positioning mechanism, and (c) an electronic control module. The panels on the console enclosure support all peripheral functions.

The major function of the off-line storage structure is to provide safe and secure space to store the magazine of storage media while it is not in use. The off-line storage structure consists of a rack design with at least one docking bay. Each docking bay is designed to park at least one disc magazine. A back panel with appropriate electronics will support active disc management. There are many ways to implement this invention, depending on how the laser discs are arranged in the magazine.

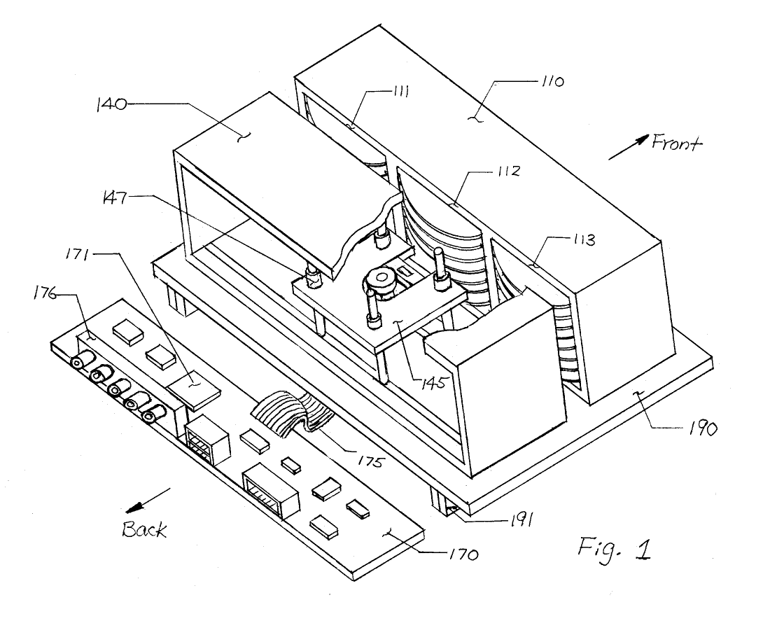

FIG. 1 displays one of the preferred embodiments of the internal modules of the operation console with a disc magazine 110 of horizontal stacking design as its determining feature. This magazine is matched with a specific design of the disc loader assembly 140, which includes the laser disc loader 145 and its positioning mechanism 147. Both the magazine 110 and the loader assembly 140 are situated on the sliding platform 190. The electronic control module 170 is connected to the laser disc loader assembly 140 by the flexible cable 175 via the platform 190.

The magazine 110 has three laser disc compartments, 111, 112 and 113, situated side by side with multiple discs stacking up in the horizontal position inside each compartment. This magazine 110 is removable therefore requires a special interface design to mate with the platform 190 precisely. (For any fixed magazine, a set of simple fasteners, such as screws or rivets, will be enough to serve the purpose.) In order to guarantee that the magazine 110 will mate with the laser disc loader assembly 140 precisely each time after it is dropped in, a set of mechanical stops must be employed. This set of mechanical stops usually adopts the forms of a properly sized recess on the surface of the platform 190 or a set of risers that are positioned strategically around the peripheral of the contact area. Regardless of the type of the stoppers used, they must be keyed to prevent the magazine being oriented in the wrong direction. In addition to being precisely positioned, the magazine 110 needs to be securely seated. Thus a set of latches are placed around the peripheral such that after the magazine 110 is dropped in into the proper location on the platform 190, the latches are engaged. This engagement may be triggered automatically by the drop-in action, or manually by the user, or electrically by the user through the action of a prime mover such as an electrical motor or a solenoid. To disengage, the design can accommodate either a manual action mechanism, or an electrical action mechanism, or both. Since the designs of the stoppers and the latches are well established, the details are omitted from this description.

The major obstacle to make portable disc magazine user friendly is the difficulty to sort out the discs in the magazine. The necessary physical construction of the laser disc loader stretches the disc access time to tens of seconds even in a single disc device. When a magazine carries dozens of discs, this sorting process will extend to an inhibitive range in the order of tens of minutes. To minimize the time need to sort out the content of the whole magazine, this device employs a fast access type of memory. This memory device must be able to retain its content while the power is off. There are two types of field programmable non-volatile memory (NVM) ICs available, namely flash memory and EEPROM, to meet the requirement. Either of them can be used in this device.

To make the magazine truly portable, a reference database will reside on the NVM. The database will contain enough information about each disc to distinguish the discs. Whenever the user feels a full scale update of the magazine database is warranted, he or she can initiated the process by pressing just one button and the resident program in the console will complete the task. Since it will take quite some time to complete, the user may want to wait to run the process overnight. For a minor update on a few replacement discs, the console will initiate the process automatically while detecting the user set flags every time a magazine is loaded into the console. The user is able to edit the database to modify information to assist future sorting.

There are two methods in which the electronic controller 170 can physically access the NVM. The first method is through wired connection. A connector is built-in onboard the magazine 110. A mating connector is installed onto the platform 190. When the magazine 110 is loaded on the platform 190, the latches will provide pressure to guarantee that the mating connectors are in close contact. The second method relies on RFID technology to provide wireless communication. The circuitry onboard the magazine 110 will harvest RF energy inductively to support NVM activity during communication.

In addition to built-in NVM, it is possible to employ add-on NVM. The add-on NVM can take the form of either standard off-the-shelf memory card such as MMC, SD, etc. or proprietary expansion memory. This will allow the user to choose the right sized memory to suit his or her specific requirement. It is also flexible. When the existing memory is approaching saturation, the user can replace it with a larger NVM.

The main function of the disc loader assembly 140 is to read data from or write data to the laser discs residing in the magazine 110. To be able to read/write a specific disc, the laser disc loader 145 must be positioned precisely at a specific location such that the disc selected can be accessed. Therefore the disc loader assembly 140 is fixed on the platform 190 precisely and constructed with a sturdy outer frame to provide the rigidity and positioning reference. The positioning mechanism is constructed with passive components such as guide rails, slides, precision screws, etc. and driven by prime movers. The processing software in the control module 170 will determine the control method. Servo amplifiers, servomotors, speed and position sensors are used for the closed-loop control. And stepping motors and drives are for the open-loop control. Those are common devices seen in both the machine tools industry and the semiconductor foundries.

It is worth mentioning that more than one disc loader 145 can be installed inside the disc loader assembly 140. Although adding extra disc loaders will make the control function more complicated both mechanically and electronically, the added data handling ability may be useful.

The platform 190 is a flat plate with latches, stoppers, connectors and mounting holes strategically located on the top surface. The mounting holes are designed to attach the disc loader assembly 140 to the platform 190 permanently. The stoppers let the magazine 110 to drop in precisely and easily. The latches hold the magazine 110 down during normal operation. The connectors put fast access memory of the magazine online with the electronic controller 170. The platform 190 is also equipped with two splitting sliding rails 191. Although FIG. 1 shows these rails 191 are mounted with one side onto the bottom of the platform 190 and the other on the bottom panel of the enclosure, they can also be mounted with one side onto the sides or even onto the top of the platform 190 and the other on the side panels of the enclosure. These rails 191 will help the platform 190 to slide off outside the enclosure through the drop-down front panel. The platform 190 will stop at a pre-determined position so the magazine 110 can be easily replaced.

The last module is the electronic control module 170 located at the rear of the enclosure. This is the nerve center of the console. Various electronic components as well as output connectors are located on this PCB. The flexible cable 175 connects it with the disc loader assembly 140 and front panel (not shown) via the platform 190. In this manner, the control module 170 will be able to establish full communication and control over the disc loader assembly 140, get full access of the fast access memory (NVM) on the magazine 110, and take commands from the user via the front panel. A set of connectors 176 is soldered onto the PCB in the rear to allow them to be accessed through the openings on the rear panel. These connectors may include both analog and digital connections. Depending on the ability of the control module 170, the analog output may include audio/visual signals that are connected to amplified speakers and TV set. The digital connection includes any combination of network connections via RJ45, IDE expansion and USB link. Other digital interfaces, such as IEEE 1394, PCMCIA, and various memory cards (MMC/SD, memory stick, CF card, etc.), may also be included.

To double the operating capacity of the console, an identically constructed magazine can be placed on the backside of the expanded platform 190, exactly on the opposite side of the current disc magazine 110. Modifications to other hardware and/or software may be necessary to accommodate the upgrade.

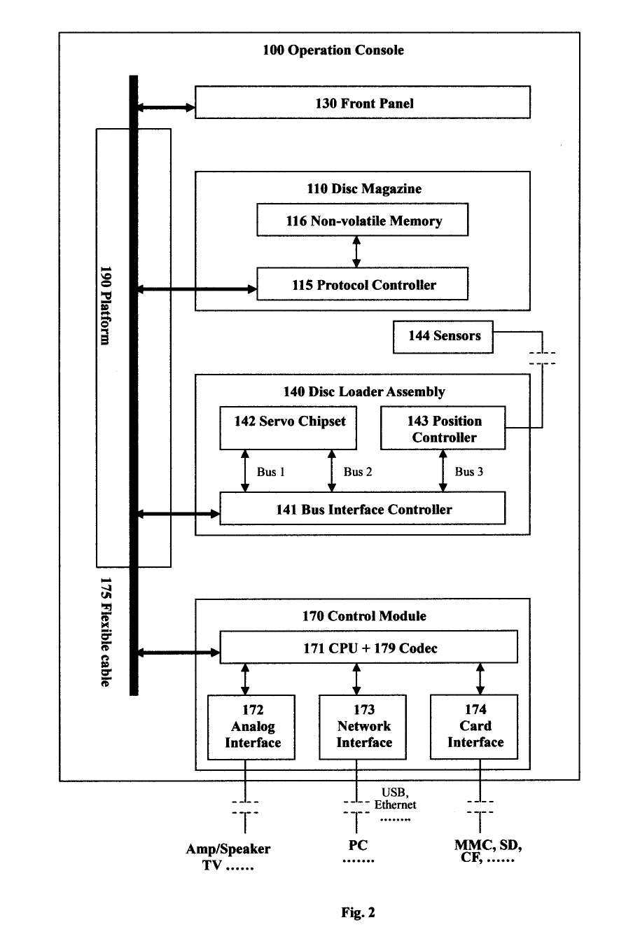

FIG. 2 displays a block diagram of the essential electrical connections of the operation console. The heart of the operation console is the electronic control module 170 which centers on the CPU 171 and the optional Codec (coder/decoder) 179. The operating system and the application software that reside in this module control the entire operation. The optional Codec 179 will extend the performance to include audio and/or visual functions to be more appealing to certain users. Codec 179 is linked to analog interface 172 which is designed to be connected to external audio/visual devices such as TV's and amplifier/speaker for output and cable TV for input. CPU 171 will be linked to network interface 173 to provide communication links such as USB or Ethernet for networking. Additional receptacles in the form of card interface 174 are also linked to CPU 171. This will broaden the ability of CPU 171 for accessing external data.

Via the flexible cable 175, the CPU 171 will exercise control over the rest of the modules in the operation console. Most traffic will come from the loader assembly 140. Its front end is the bus interface controller 141 which manages the communication with the CPU 171. The complexity varies for the controller 141, depending on the bus standard it follows. For instance, if an IDE bus is employed, the controller 141 will execute ATAPI command set. In some other cases, the controller 141 can even be transparent. The servo chipset 142 is connected to the bus controller 141 through two sets of bus. Bus 1 follows 1²S standard as dedicated data communication bus. Bus 2 allows the CPU 171 to dictate track location of the laser read/write head. The position controller 143 is employed to align the loader 145 with the desired disc position determined by the CPU 171. The sensors 144 are employed only if a closed-loop design is chosen. This positioning mechanism can be looked upon as a scale-down version of machine tools control.

The advantage of this invention is the inclusion of fast access memory in the form of non-volatile memory (NVM) 116 on board the disc magazine 110 permanently or semi-permanently. NVM 116 is a memory IC classified in the category of either “flash memory” or “EEPROM”. The CPU 171 will access this NVM 116 through the help of protocol controller 115. If a built-in NVM option is chosen, then the memory IC will reside on the magazine 110 permanently and protocol controller 115 is reduced to direct wiring or RF link. If an add-on NVM option is selected, the NVM will be in the form of either standard flash card such as MMC, SD or even proprietary flash card. Then the protocol controller 115 will be part of the card circuitry aided by direct wiring or RF link.

The content of the NVM 116 is taken from the TOC section of each laser disc in the magazine 110. Since the laser disc follows the IS09660 standard and its extensions, the CPU 171 shall interpret the content of the NVM 116 accordingly.

There are two ways to establish the link between the CPU 171 and the NVM 116. One method is via a matching pair of electrical connectors on both the magazine 110 and the platform 190. When the magazine 110 is properly seated on the platform 190, the matching electrical connectors will make positive contact thus complete the circuitry. The other method is to use RFID technology when physical contact is not feasible. In this case the NVM 116 and its protocol controller 115 are packed with a large loop antenna to be installed onto the magazine 110. The read/write circuit with matching antenna resides on the platform 190. When the CPU 171 initiates a read/write process, the circuit on the platform 190 will issue the commands by emitting the signal with proper level of RF energy. The receiving antenna on the magazine 110 will harvest this energy and using it to drive both the protocol controller 115 and the NVM 116 for proper response. No matter which method is employed, it will accomplish these tasks: 1) To have a NVM 116 permanently on board the magazine 110 to be carried around with the magazine; 2) To allow the memory operate normally without carrying energy source on board the magazine 110.

Front panel 130 is designed to provide a simple interface to the user. It usually consists of simple keypad for simple command and display panel for simple status information. An infrared receiver may be added to accommodate a remote control. However since the back panel provides high speed connection such as USB and Ethernet, the serious control functions shall be accomplished via these ports.

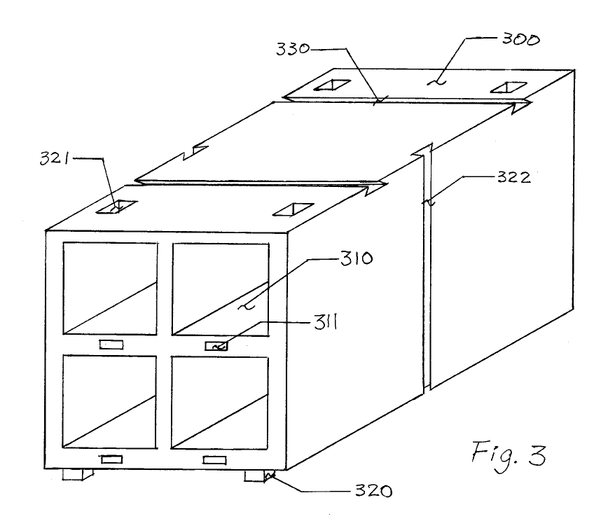

FIG. 3 displays one of the preferred embodiments of the storage rack unit 300 for safe and secure off-line storage of the disc magazine 110. An example is a four docking bay 310 design. Racks with other numbers of the docking bay are possible as long as the material is strong enough to guarantee the structure integrity. It is preferable to dock one magazine in each bay, although multiple parking is mechanically possible with larger bay. Inside each bay, a latching device is engaged whenever a magazine is pushed in place. The push button 311 in the front is the manual release of the engagement device. When pushed, the device will pop the magazine at least one fifth of the way out for easy retrieval. An optional electrical releasing device may also be employed and controlled through the connection on the back panel. When triggered, it will function similarly to the manual release. The short stands 320 at the bottom and the shallow indents 321 on the top are designed to help stacking the structure upward, as high as the material strength can hold. Latches on the sides such as the dovetail slots 322 are designed to help secure vertical stacking. The latches on the top surface, such as the dovetail slot 330, are designed to allow horizontal expansion.

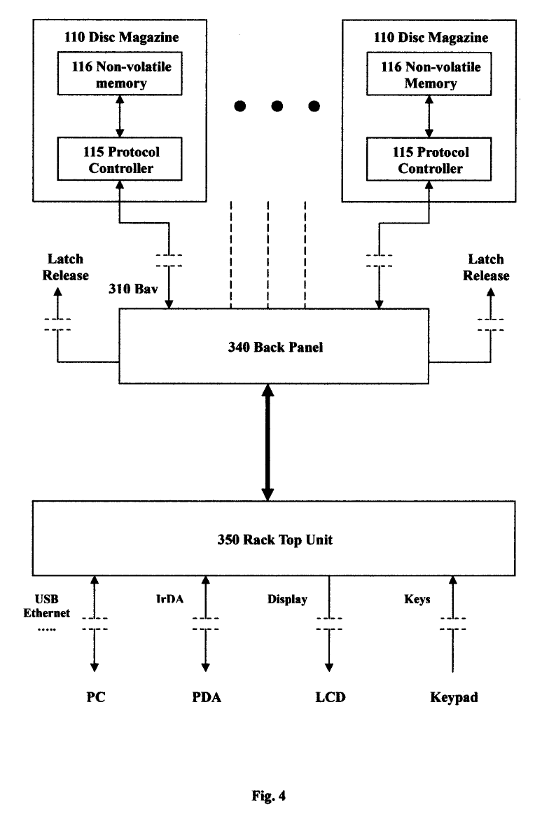

FIG. 4 displays the block diagram of the electrical connection for the storage rack unit 300. When securely stored in place, the NVM of the magazine 110 is connected to the back panel 340 through either direct wiring or RF link. If it is designed for wired connection, there will be an electrical connector on the bay structure 310 to mate with the corresponding connector on the magazine 110. If it is designed for wireless connection, then there will be an antenna installed on the bay structure 310 to provide enough RF power to the mating antenna on the magazine 110 to establish the communication and power link. Refer to FIG. 2 for more detailed description. Electrical latch release mechanism, if any, for each bay may also be connected through the back panel 340 and controlled by rack top unit 350. On the back panel 340 of the storage unit 300, all connections are bundled into the larger scheme of a bus structure to allow each individual bay to be connected to rack top unit 350. On this unit, there may be communication means to allow a user to plug a keypad and LCD display to it. It may also provide other connections such as USB, Ethernet or IrDA to allow the user to use a PDA or PC for a broader range of access in addition to browsing and managing the storage.

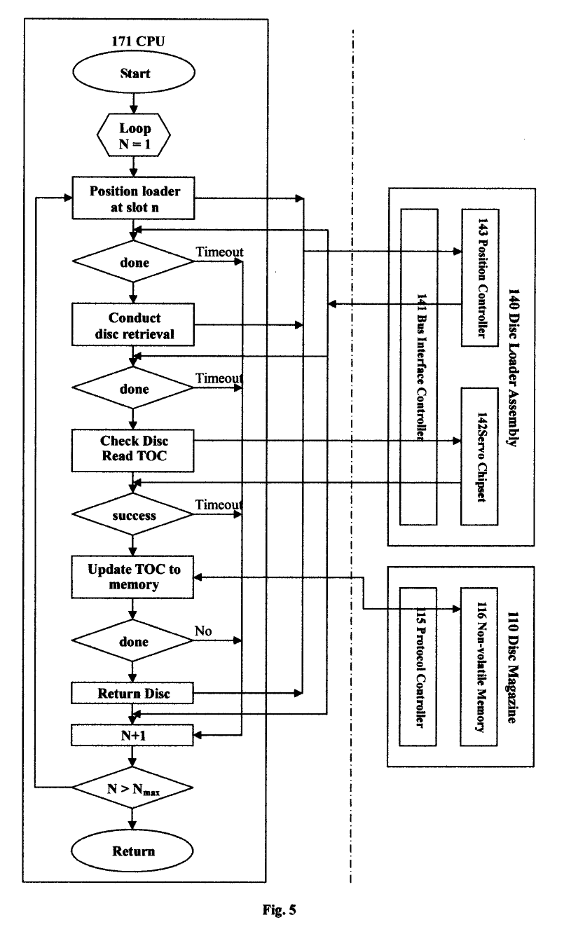

FIG. 5 displays the block diagram of the normal sorting procedure for the entire content of the disc magazine 110 under user command. Since the mechanical process of loading, unloading and reading even a single laser disc takes considerable amount of time, to sort through the entire cache of the magazine 110 is a time consuming task. It may literally take up over dozens of minutes. Hence it is not practical to have this process initiated automatically. The user has to specifically request this procedure by pressing a button on the front panel, or issuing a discrete command through a networking computer or PDA. After receiving the request, the CPU 171 will first ascertain that the platform 190 and the magazine 110 are both in place then calling up the procedure as shown in FIG. 5. When activated, the program starts at slot number one on the magazine 110. It commands the position controller 143 to bring the disc loader assembly 140 to the proper position then to retrieve the disc. When this is done, it commands the servo chipset 142 to spin and check the disc. If the disc is in place and readable, the CPU 171 will take the next step to read the TOC section of the disc according to ISO9660. The successfully read TOC data is then written onto the NVM 116 on board the disc magazine 110. This process will repeat until all disc slots have been visited. And for each step that requires communicating with other subassembly, there is a time-out mechanism built in to prevent hang up due to failure to respond by that subassembly. Since the sorting is done automatically once it is activated, the user can select the least disruptive time period to let it carry out.

As for the database on the NVM 116 onboard the magazine 110, the user can access that via a networking computer running a specially designed access program. The user can modify the information in each section of the database to make it more descriptive.

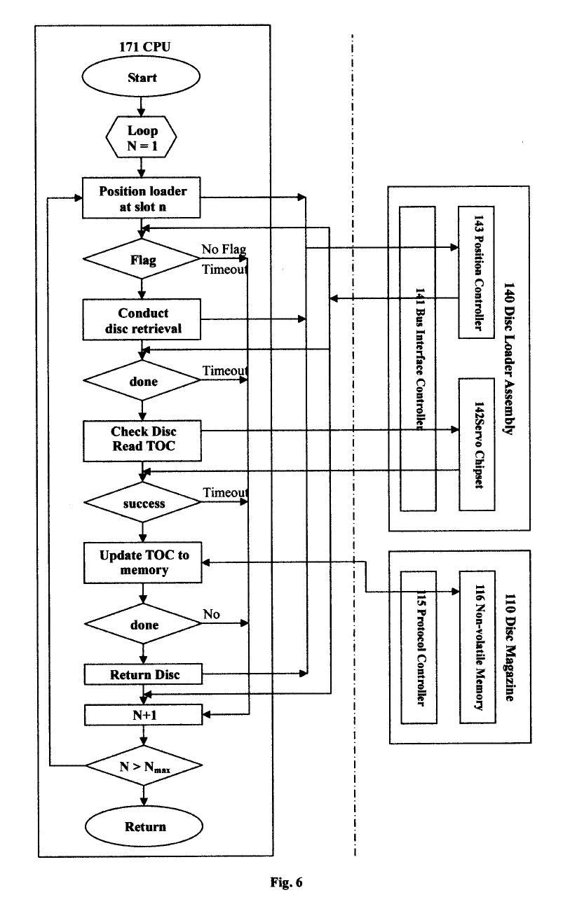

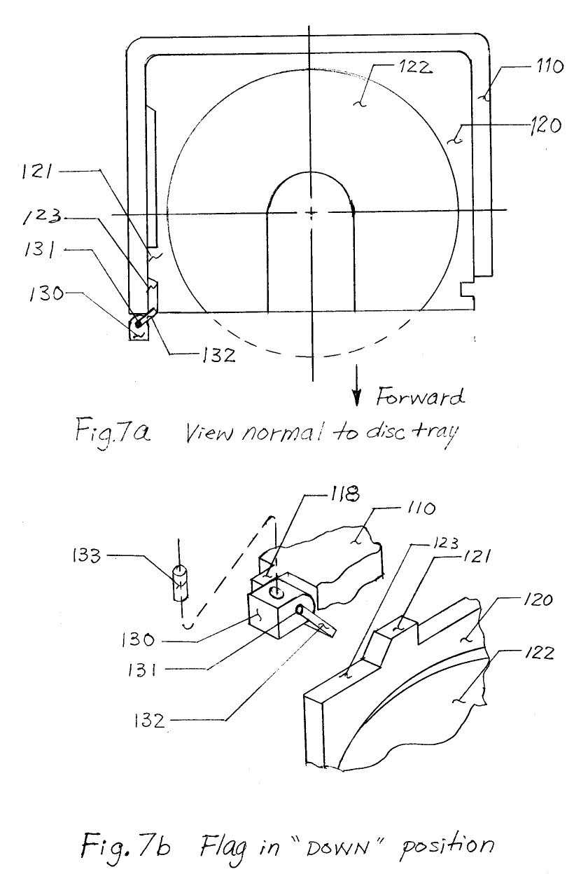

FIG. 6 displays the block diagram of the automatic updating procedure immediately after a disc magazine 110 is loaded. Every time when a new magazine 110 is loaded onto the platform 190, the program starts an automatic procedure to make sure that the database on the NVM 116 onboard the magazine 110 is up to date. This procedure is part of the initialization process. Since it is done automatically every time a new magazine 110 is loaded, speed is of the essence. To accomplish this, a flag setting mechanism is employed. An example of the preferred embodiments of the flag is shown in FIG. 7. Every time after the user replaces, during off-line, a disc in the magazine 110, the attached flag at that slot will be raised by the user. A sensing device on the loader will be triggered when the loader is passing through within close proximity to the flag. The CPU 171 will command the position controller 143 to position the loader at the precise location then retrieve the disc. The CPU 171 will then command the loader to read the disc of its TOC, and then update the database on the NVM 116 onboard the magazine 110 with new disc TOC information. The movement that returning the disc to its slot in the magazine 110 will lower the flag to signal that the database has been updated for this particular disc. The loader assembly then moves on to the next raised flag and repeats the procedure until all flags are serviced.

FIG. 7 displays one of the preferred embodiments of the flag setting mechanism to optically or magnetically signal the replacement of a disc in the disc magazine 110. FIG. 7a takes the view looking vertically into the disc and tray. It shows the tray 120 is in the retract position. The disc resides in the circular recess 122. In the current position, the tray 120 can only slide forward to leave the constraint of the magazine 110. The flag 130 is a small block hinged to the magazine 110 by a pin 131. Flag 130 has the freedom to rotate within 90 degrees range about the pin 131. A flap 132 is implanted in the flag 130 in the radial direction aligning with the pin 131. The flap 132 is made of sturdy but flexible material. The trigger 121 on the side of the tray 120 is designed specifically to turn the flag 130 “up” and “down” while the tray 120 moves forward and backward respectively.

FIG. 7b is an exploded view, from a different angle, of the flag 130 in “down” position with the trigger 121. In this case, the trigger 121 is backward to the flag 130, which is in parallel with the wall of the magazine 110. The flap 132 will not interfere with the tray 120 due the proper cutout 123. With the pin 131 the flag 130 is attached to the support 118, which is part of the structure of the magazine 110. The forward surface of the flag 130 is coated with non-reflective material so the photo sensitive type proximity sensor attached to the disc loader 145 will not detect the flag 130. If a Hall effect proximity sensor is used, then a magnetic stud 133, with its axis parallel to the forward surface, is dropped into the flag 130 as shown. In this case the Hall effect sensor will not detect the flag 130 either, due to the stud position. Hence the flag 130 is “down”.

FIG. 7c is an exploded view of the flag 130 in “up” position with the trigger 121. In this case, the surface 134 of the flag 130 is coated with highly reflective material, so the photo sensitive type proximity sensor attached to the disc loader 145 will detect the flag 130. If the optional magnetic stud 133 is implanted, its pole is now turned facing the forward direction. A Hall effect proximity sensor that attached to the disc loader 145 will sense the flag 130. Thus the flag 130 is in “up” position.

In the situation described by FIG. 6, the user needs to turn the flag 130 “up” on that particular slot after replacing the disc. The user has to act deliberately because pushing the tray 120 backward into storage position after replacing the disc will automatically set the flag 130 “down”. This is also the mechanism that turns the flag 130 “down” after the CPU 171 commands an auto update and returns the disc (and tray 120) back inside the magazine 110.

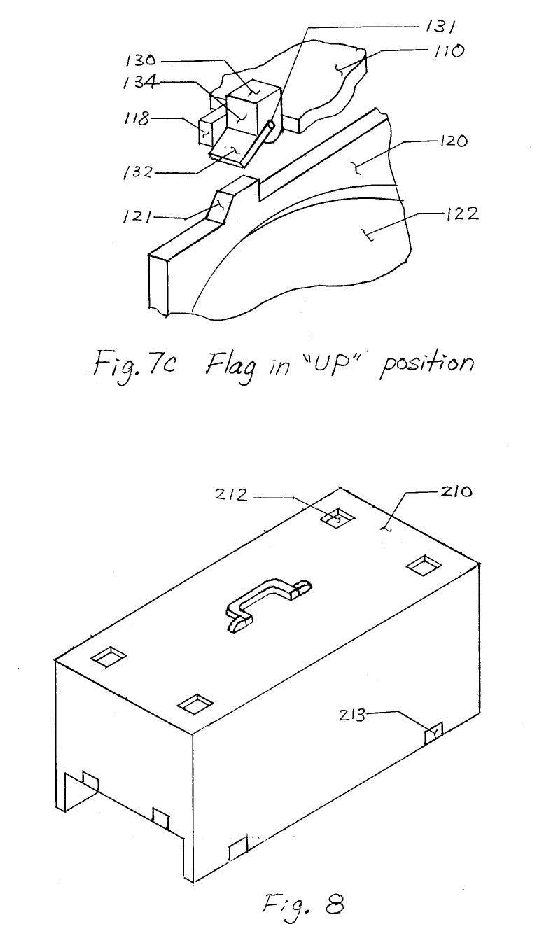

FIG. 8 displays one of the preferred embodiments of the cover/carrying case 210 for the disc magazine 110. It is actually an absolute necessary accessory of the magazine 110. The latching points 213 will allow the cover being latched to the magazine 110 securely. Thus while off-line, this is the protective cover to shield the discs from foreign object damage. The detailed description of the latches is omitted, since there are various latch designs suitable for this job and available for years. The indents 212 will even allow covered magazine 110 to stack on top of each other (to a limited height) while temporarily outside the docking bay 310. With the handle 211, this cover 210 will act as a carrying case during transport phase. While installing onto the platform 190, this cover 210 is supposed to help speed up the process due to its easy handling features (comparing with bare magazine 110). After the installation, the cover 210 will be removed to allow free access to the discs.

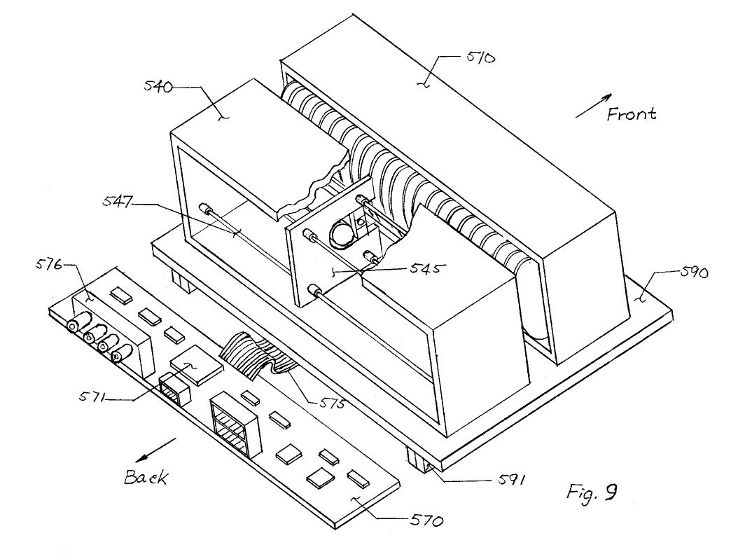

FIG. 9 displays another of the preferred embodiments of the internal modules of the operation console. This console is very similar to the one shown in FIG. 1. The minor deviation includes that the disc magazine 510 packs the discs by letting them standing on their side compared to the discs sitting horizontally in the magazine 110. To match this change, the disc loader assembly 540 has reduced its complexity by limiting the disc loader 545 to traverse only horizontally, since elevating the disc loader 545 is no long necessary. The rest of the operation of this system is identical to the system shown in FIG. 1, so further discussion is omitted. It is worth mentioning that a cover similar to the cover 210 described in FIG. 8 shall be used for the magazine 510.

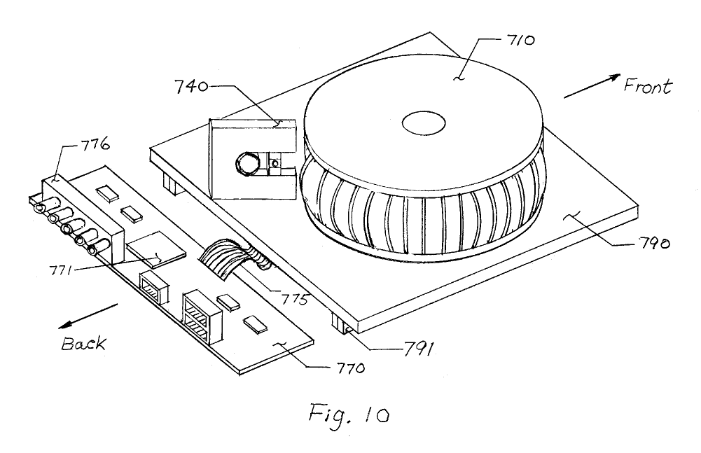

FIG. 10 displays yet another of the preferred embodiments of the internal modules of the operation console. In this case a rotating carrousel disc magazine 710 has replaced the stationary magazine 110. To match this, a fixed disc loader assembly 740 replaces the traveling loader assembly 140. One complication rises with the rotating carrousel. It makes wired contact to the onboard NVM difficult. The obvious solution is to use RFID technology to establish the link just as mentioned in FIG. 2. The rest of the operation of this system is identical to the system shown in FIG. 1, so further discussion is omitted.

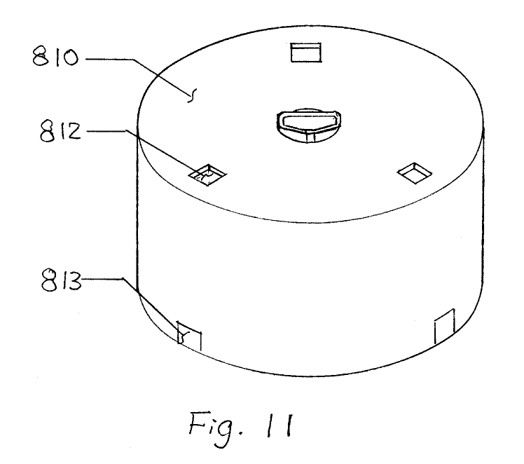

FIG. 11 displays one of the preferred embodiments of the cover/carrying case 810 for the disc magazine 710. The purpose to have this cover/carry case 810 is identical to that of cover 210, therefore detailed description is omitted.

What is claimed is:

1. A removable laser disc mass storage apparatus, designed to provide unlimited, modular data storage capacity to service either individual computation devices such as, but not limited to, PC's, USB-equipped video decoders, game consoles, etc., through an individual data link, or multiple computation devices of similar functionality through a shared network, wherein said apparatus comprises:
a housing structure with a flip-down front panel, allowing a tracked platform to slide in and out of the housing structure through the front opening;
a laser disc magazine, supported by said tracked platform, with the capacity to hold a large number (i.e. dozens or more) of laser discs, that is designed to hold said laser discs in close proximity to conserve space;
a positioning structure, supported by said tracked platform, that allows precise positioning of a laser disc loader and disc retrieval mechanism relative to said laser disc magazine to load the selected disc onto said laser disc loader;
a controlling electronic circuit board, housed inside said housing structure, which commands and controls said positioning structure, supports an EIDE bus to communicate with laser disc drive and optional hard disc drive (“HDD”) and communicates and interfaces with said shared network to perform data transfer and storage functions;
a system image management program, residing on said controlling electronic board, to manage the system images of every computation device linked via said network;
a full scanning program, residing on said controlling electronic board, to conduct full scans over said magazine as necessary;
a selective scanning program, residing on said controlling electronic board, to conduct selective scans over specific slot of said magazine as necessary;
a streaming flow management program, residing on said controlling electronic board, that utilizes said HDD as a buffering device to optimize data throughput to said computation devices.

2. The removable laser disc mass storage apparatus of claim 1, wherein said laser disc magazine comprises:
a multi-slot structure, with the capacity to hold a large number (i.e. dozens or more) of laser discs in close proximity;
embedded electronic circuit elements consisting of communication circuitry to interface with said controlling electronic circuit board, controlling circuitry to interface with onboard nonvolatile silicon memory which will be in the form of either, or both, a single (or bank of) nonvolatile memory chip(s) or standard connectors such as, but not limited to, MMC, SD, SMC, memory stick, CF, etc., which connectors will be ready to receive corresponding memory cards.

3. The removable laser disc mass storage apparatus of claim 1, wherein said laser disc magazine comprises:
a flag mechanism on each slot allowing the user to set said flag as desired when a new laser disc is being loaded into said slot.

4. The removable laser disc mass storage apparatus of claim 1, wherein said controlling electronic circuit board comprises:
a high speed CPU capable of running, at a minimum, a Windows CE, or embedded Linux operating system;
a cache of write-protected nonvolatile memory with enough capacity to hold said operating system;
a cache of RAM to provide scratch space for proper operation of the system;
an option to have a single or multiple HDD to provide buffer space for data from various said laser discs to increase data throughput to said computation devices sharing said shared network;
a collection of interfaces such as, but not limited to, USB, Ethernet, serial port, etc., to provide communication capabilities to peer computation devices which share said network as well as human users.

5. The removable laser disc mass storage apparatus of claim 1, wherein said system image management program comprises:
a software program, residing on said controlling electronic circuit board, managing and safe keeping the system images of various states of each said computation device on said network and allowing said computation device to restore itself to a known state on demand via loading a specific group of system images.

6. The removable laser disc mass storage apparatus of claim 1, wherein said full scanning program comprises:
a software program, residing on said controlling electronic circuit board, under the command of a single stroke input via said interface on said controlling circuit board to fully scan every individual laser disc contained in the laser disc magazine.

7. The removable laser disc mass storage apparatus of claim 1, wherein said selective scanning program comprises:
a software program, residing on said controlling electronic circuit board, conducting active searches for said flags whenever said laser disc magazine is freshly loaded, and performing disc scans on said laser discs in the slots where said flags are found.

8. The removable laser disc mass storage apparatus of claim 1, wherein said streaming flow management program comprises:
a software program, residing on said controlling electronic circuit board, predicting streaming demand from each computation device on said shared network to determine and provide the optimum throughput to each individual computation device.

9. A laser disc magazine off-line holding apparatus, designed to provide safe keeping of said laser disc storage magazines once removed (off-line laser disc magazines) from said removable laser disc mass storage apparatus, wherein said holding apparatus comprises:
a holding apparatus structure that is designed and built to or can be reinforced to withstand being stacked up into storage banks;
one or more cavities (holding bays) formed into said structure to hold and provide safe keeping of said off-line laser disc magazines;
an expandable back panel with electronic logic circuitry to connect all non-volatile memory on said off-line laser disc magazines with external computation devices, such as, but not limited to, PDAs, laptop PCs, etc., for external access and management of data on said nonvolatile memory embedded in off-line laser disc magazines;
electrical connector(s) which match that on said off-line laser disc magazines associated with said nonvolatile silicon memory of magazines to provide leads to said expandable back panel.

10. A laser disc magazine off-line holding apparatus of claim 9, wherein said holding apparatus structure comprises:
a holding apparatus structure, built with sturdy and load bearing material or able to be reinforced by such material such that multiple numbers of said structures can be stacked into large storage bank with structural integrity.

11. A laser disc magazine off-line holding apparatus of claim 9, wherein each said holding bay comprises:
a cavity of appropriate size on said holding apparatus structure such that a single said off-line laser disc magazine can be placed horizontally into a precise location of said holding bay and retrieved from said holding bay with simple operation.

12. A laser disc magazine off-line holding apparatus of claim 9, wherein said expandable back panel comprises:
an individual panel, designed to electrically connect and mechanically match to one said holding apparatus, able to connect to other similar panels when said holding apparatus is stacked into said storage bank, allowing access to and monitoring of said nonvolatile memory embedded in said off-line laser disc magazines placed in said holding bays of said storage bank by computation devices such as, but not limited to, PC, PDA, etc.

13. A laser disc magazine off-line holding apparatus of claim 9, wherein said electrical connector(s) comprises:
electrical connector(s) with corresponding logic electronic circuitry embedded precisely into each said holding bay of said holding apparatus structure such that when said off-line laser disc magazine is placed inside said holding bay, its non-volatile silicon memory is connected through said electrical connector(s) to the electronic circuit embedded in said holding apparatus.
